(19) United States
(12) Patent Application Publication
(10) Pub. No.: US 2012/0238333 A1
(43) Pub. Date: Sep. 20, 2012

(54) ELECTRONIC DEVICE

(75) Inventors: Masatomo Mori, Kawasaki (JP); Yoshifumi Kajiwara, Sapporo (JP); Haruyoshi Yada, Sapporo (JP); Kazunori Murayama, Ichikawa (JP)

(73) Assignee: FUJITSU LIMITED, Kawasaki-shi (JP)

(21) Appl. No.: 13/419,519

(22) Filed: Mar. 14, 2012

(30) Foreign Application Priority Data
Mar. 18, 2011 (JP) 2011-061766

(51) Int. Cl. H04W 88/02

(52) U.S. Cl. 455/575.4

(57) ABSTRACT

There is provided an electronic device which includes a first and second casings, a second casing including a recess disposed on a surface, opposite to the first casing, of the second casing, and a joint for connecting the first casing to the second casing so that the first casing and the second casing are movable relative to each other. The joint includes a movable member which is fixed to the first casing and includes two arms, a pair of rails which is fixed to the second casing, each of the pair of rails receiving a corresponding one of the two arms so that the two arms are slidable relative to the pair of the rails, and a protrusion protruding from the movable member. The recess is disposed between the pair of rails and the recess receives the protrusion and regulates movement of the protrusion.

### CROSS-REFERENCE TO RELATED APPLICATION

This application is based upon and claims the benefit of priority of the prior Japanese Patent Application No. 2011-061766, filed on Mar. 18, 2011, the entire contents of which are incorporated herein by reference.

### FIELD

The embodiment discussed herein is related to electronic devices.

### BACKGROUND

Today, electronic devices such as mobile phone devices having a fixed casing on an operation side and a movable casing on a display side are widely known. These fixed and movable casings are connected to each other using connecting portions to allow the fixed and movable casings to perform movement in a rotating manner or a sliding manner relative to each other. FIGS. 10 and 11 illustrate an example of the structure of a related-art electronic device equipped with the above-described connecting portion. FIG. 10 is an external perspective view of the related-art electronic device. FIG. 11 is an exploded perspective view of the related-art electronic device.

As illustrated in FIGS. 10 and 11, the related-art electronic device has a fixed casing 210 on the operation side and a movable casing 230 on the display side. The fixed and movable casings 210 and 230 are connected to each other such that the fixed and movable casings 210 and 230 are movable relative to each other using a connecting portion 250. The fixed casing 210 includes a fixed-side front casing 212, a circuit board 214, and a fixed-side rear casing 216. The fixed-side front casing 212 opposes the movable casing 230. The fixed-side rear casing 216 is mounted to the fixed-side front casing 212 with the circuit board 214 disposed therebetween. The movable casing 230 includes a movable-side rear casing 232, a circuit board 234, and a movable-side front casing 236. The movable-side rear casing 232 opposes the fixed casing 210. The movable-side front casing 236 is mounted to the movable-side rear casing 232 with the circuit board 234 disposed therebetween.

The connecting portion 250 includes a movable member 252 and a rail plate 254. The movable member 252 is secured to a surface of the fixed-side front casing 212 opposite the movable casing 230. The rail plate 254 is secured to a surface of the movable-side rear casing 232 opposite the fixed casing 210. The movable member 252 includes a base plate 256 and a swing plate 258. The base plate 256 is attached to the fixed-side front casing 212. The swing plate 258 is rotatably supported by the base plate 256. A protruding portion 260 protrudes from the base plate 256 on the swing plate 258 side. The protruding portion 260 is inserted through an arc-shaped through hole 258a formed in the swing plate 258 to extend toward the rail plate 254 side. The rail plate 254 has a pair of rail portions 262, a sheet metal portion 264, and a hole portion 266. The rail portions 262 receive arm portions 258b of the swing plate 258 such that the arm portions 258b are slidable relative to the rail portions 262. The sheet metal portion 264 connects the pair of rail portions 262 to each other. The hole portion 266 is formed in the sheet metal portion 264 so as to be interposed between the pair of rail portions 262. The hole portion 266 receives the protruding portion 260 such that the protruding portion 260 is movable relative to the hole portion 266 while the hole portion 266 regulates a movable range of the protruding portion 260.

When a moving operation of the electronic device is performed, the movable casing 230, to which an external force is applied, moves relative to the fixed casing 210, and the protruding portion 260 moves in the hole portion 266 within the range regulated by the hole portion 266. Thus, the movable casing 230 may slide or rotate relative to the fixed casing 210.

Japanese Laid-open Patent Publication No. 2010-239592 is an example of related art.

### SUMMARY

According to an aspect of the invention, an electronic device includes a first casing, a second casing including a recess, the recess being disposed on a surface of the second casing, the surface being opposite to the first casing, and a joint configured to connect the first casing to the second casing so that the first casing and the second casing are movable relative to each other. The joint includes a movable member fixed to the first casing, the movable member including two arms, a pair of rails fixed to the second casing, each of the pair of rails receiving a corresponding one of the two arms so that the two arms are slidable relative to the pair of the rails, and a protrusion protruding from the movable member, the protrusion being disposed between the pair of rails, wherein the recess is disposed between the pair of rails, and the recess receives the protrusion and regulates movement of the protrusion.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an external perspective view illustrating a closed state of a mobile phone device according to an embodiment;

FIG. 2 is an external perspective view illustrating an open state of the mobile phone device according to the present embodiment;

FIG. 3 is an external perspective view illustrating a rotated state of the mobile phone device according to the present embodiment;

FIG. 4 is an exploded perspective view of the mobile phone device according to the present embodiment;

FIG. 5 is a perspective view of a connecting portion mounted in a movable casing seen from a fixed casing side;

FIG. 6 is an exploded perspective view of the connecting portion illustrated in FIG. 5;

FIG. 7 is a schematic sectional view of a movement regulating recess portion and an area around the movement regulating recess portion of the mobile phone device;

FIG. 8 is an enlarged perspective view of a roller member;

FIG. 9 illustrates the relationship between a pair of rail members and antennas;

FIG. 10 is an external perspective view of a related-art electronic device; and

FIG. 11 is an exploded perspective view of the related-art electronic device.

### DESCRIPTION OF EMBODIMENT

Preliminary Consideration

As described in the background, the related-art electronics device include The connecting portion 250 for connecting the casings includes the rail plate 254 in which the pair of rail portions 262 are connected with the metal sheet portion 264. Accordingly, the rail plate 254 causes increase of weight of the device. Instead of the metal rail plate 254, it is possible to adopt a resin rail plate. However, it will be necessary to increase a thickness of the resin rail plate to ensure an equivalent strength to the metal rail plate 254. As a result, the resin rail plate may cause increase of thickness of the electronic device.

An embodiment of an electronic device disclosed herein will be described below with reference to the drawings. In the embodiment below, a mobile phone device exemplifies the electronic device disclosed herein. However, the technology of the electronic device disclosed herein may also be realized in a variety of electronic devices other than mobile phone devices such as personal computers, personal digital assistants (PDAs), portable game machines, and so forth.

### Embodiment

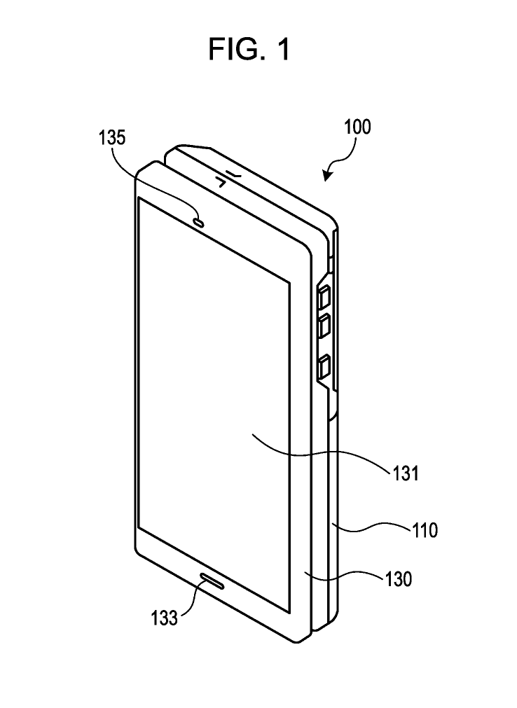

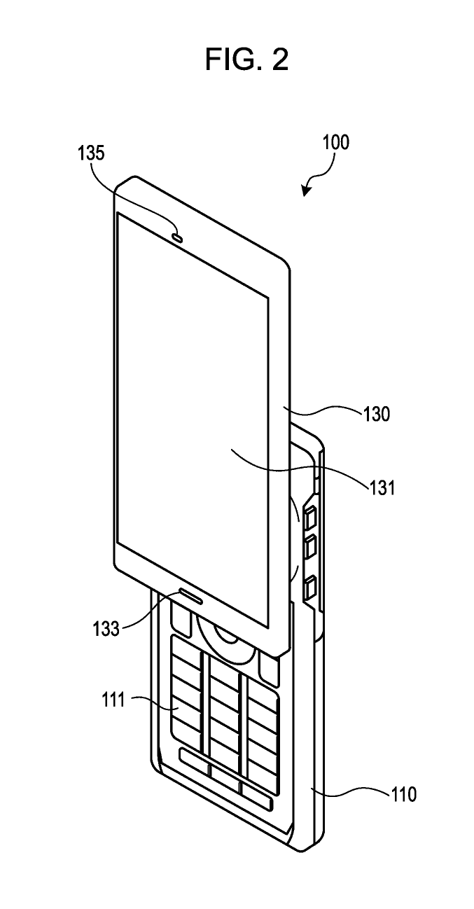

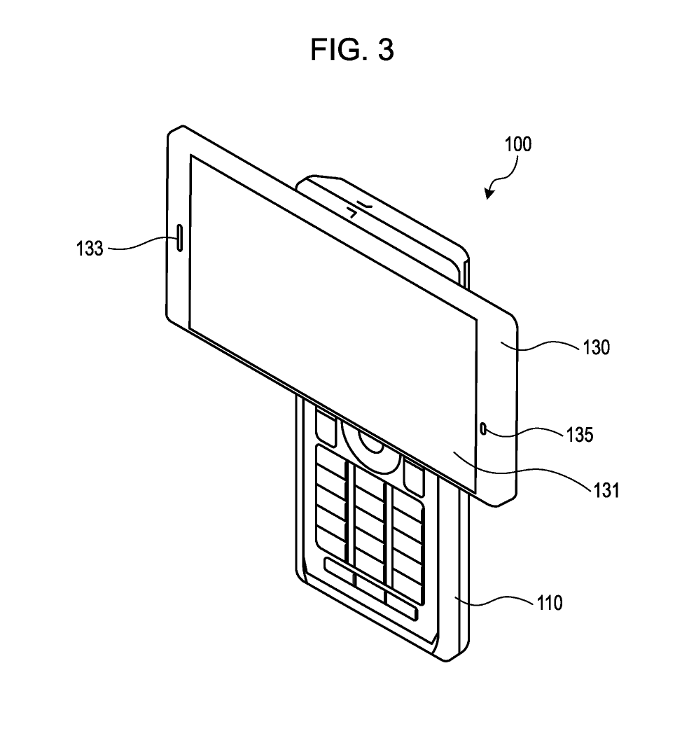

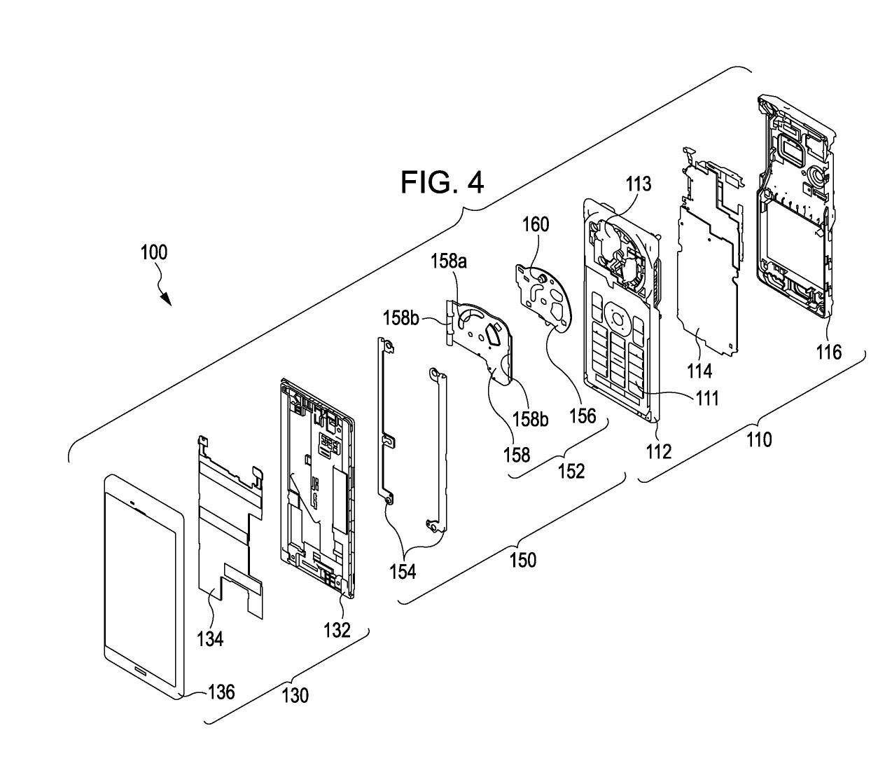

The structure of a mobile phone device 100 according to the present embodiment will be initially described. FIG. 1 is an external perspective view illustrating a closed state of the mobile phone device 100 according to the present embodiment. FIG. 2 is an external perspective view illustrating an open state of the mobile phone device 100 according to the present embodiment. FIG. 3 is an external perspective view illustrating a rotated state of the mobile phone device 100 according to the present embodiment. FIG. 4 is an exploded perspective view of the mobile phone device 100 according to the present embodiment.

As illustrated in FIGS. 1 to 3, the mobile phone device 100 includes a fixed casing 110 and a movable casing 130. The fixed casing 110 is a casing on an operation portion side, and the movable casing 130 is a casing on a display portion side. The fixed casing 110 includes an operation portion 111 in which operation buttons are provided. The movable casing 130 includes a display panel 131, a microphone 133, and a loudspeaker 135. The microphone 133 and the loudspeaker 135 are used for voice communication.

The fixed casing 110 and the movable casing 130 are connected to each other using a connecting portion 150 or a joint 150 illustrated in FIG. 4 such that the fixed casing 110 and the movable casing 130 are movable relative to each other. By sliding or rotating the movable casing 130 relative to the fixed casing 110 using the connecting portion 150, the state of the mobile phone device 100 may be changed into one of the closed state illustrated in FIG. 1, the open state illustrated in FIG. 2, and a rotated state illustrated in FIG. 3.

In the closed state illustrated in FIG. 1, the fixed casing 110 and the movable casing 130 overlap each other with a maximum overlapping area. The entire length of the mobile phone device 100 in the longitudinal direction will be the minimum in this closed state. For this reason, the mobile phone device 100 is set to the closed state when, for example, the mobile phone device 100 is carried, or simple functions, which may be performed without the use of the operation portion 111, such as checking of call records are used.

In the open state illustrated in FIG. 2, the fixed casing 110 and the movable casing 130 overlap each other with a minimum overlapping area by sliding the movable casing 130 relative to the fixed casing 110. The entire length of the mobile phone device 100 in the longitudinal direction will be the maximum in this open state. The operation portion 111 of the fixed casing 110 is exposed in the open state. For this reason, the mobile phone device 100 is set to the open state, for example, during a phone call or when performing operations using the operation portion 111 such as creation of a text message.

In the rotated state illustrated in FIG. 3, the movable casing 130 has been rotated relative to the fixed casing 110 by 90°. In the rotated state, the display panel 131 is longer in the lateral direction. For this reason, the mobile phone device 100 is set to the rotated state when, for example, moving images are being watched or web pages are being explored.

As illustrated in FIG. 4, the fixed casing 110 includes a fixed-side front casing 112, a circuit board 114, and a fixed-side rear casing 116. The fixed-side front casing 112 opposes the movable casing 130. The fixed-side rear casing 116 is mounted to the fixed-side front casing 112 with the circuit board 114 disposed therebetween. A surface of the fixed-side front casing 112 opposite the movable casing 130 is formed to have a substantially rectangular shape. The operation portion 111 is disposed on one of short edge sides of the surface of the fixed-side front casing 112 opposite the movable casing 130. On the other short edge side of the surface of the fixed-side front casing 112 opposite movable casing 130, a recess portion 113 that receives a base plate 156 of the connecting portion 150 is formed. The base plate 156 will be described later.

The movable casing 130 includes a movable-side rear casing 132, a circuit board 134, and a movable-side front casing 136. The movable-side rear casing 132 opposes the fixed casing 110. The movable-side front casing 136 is mounted to the movable-side rear casing 132 with the circuit board 134 disposed therebetween.

The connecting portion 150 is disposed between the fixed casing 110 and the movable casing 130. The connecting portion 150 connects the fixed casing 110 and the movable casing 130 to each other such that the fixed casing 110 and the movable casing 130 are slidable and rotatable relative to each other.

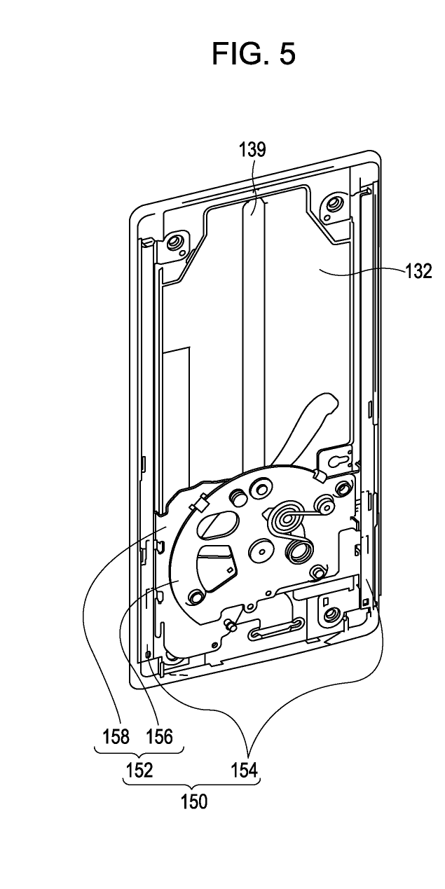

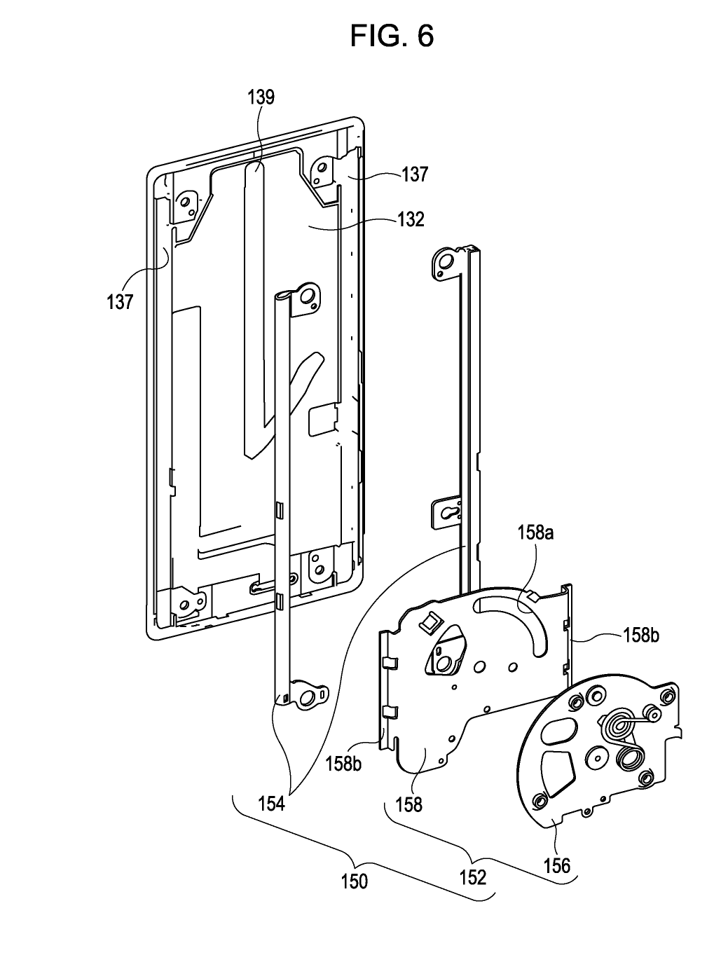

Next, the details of the connecting portion 150 and the movable casing 130 will be described. FIG. 5 is a perspective view of the connecting portion 150 mounted in the movable casing 130 seen from the fixed casing 110 side. FIG. 6 is an exploded perspective view of the connecting portion 150 illustrated in FIG. 5. As illustrated in FIGS. 4 to 6, the connecting portion 150 includes a movable member 152 and a pair of rail members 154.

The movable member 152 is formed of metal and secured to a surface of the fixed casing 110 opposite the movable casing 130. The movable member 152 includes the base plate 156 and a swing plate 158. The base plate 156 is received by the recess portion 113 of the fixed-side front casing 112 and secured to the fixed casing 110 with screws or the like. The swing plate 158 is rotatably supported by the base plate 156. A protruding portion 160 protrudes from the base plate 156 on the swing plate 158 side. The protruding portion 160 is inserted through an arc-shaped through hole 158a in the swing plate 158 and disposed between the pair of rail members 154. The swing plate 158 has a pair of arm portions 158b each of which extend toward a corresponding one of the pair of rail members 154.

The pair of rail members 154 are formed of metal and secured to a surface of the movable casing 130 opposite the fixed casing 110. The recess portions 137 are formed in the surface of the movable-side rear casing 132 opposite the fixed casing 110. Each of the recess portions 137 has a substantially rectangular shape. The recess portions 137 receive the pair of rail members 154 along two long edge sides of the surface of the movable-side rear casing 132 opposite the fixed casing 110. The pair of rail members 154 are received by the recess portions 137 of the movable-side rear casing 132 and secured to the surface of the movable casing 130 opposite the fixed casing 110 with screws or the like. Each rail member 154 receives a corresponding one of the pair of arm portions 158b of the movable member 152 such that the arm portions 158b are slidable relative to the rail members 154.

As illustrated in FIGS. 5 and 6, the surface of the movable-side rear casing 132 opposite the fixed casing 110 has a movement regulating recess portion 139 formed therein. The movement regulating recess portion 139 is interposed between the pair of rail members 154. The movement regulating recess portion 139 is formed to have a substantially L shape in a direction in which the movable casing 130 slides relative to the fixed casing 110 and in a direction in which the movable casing 130 rotates relative to the fixed casing 110.

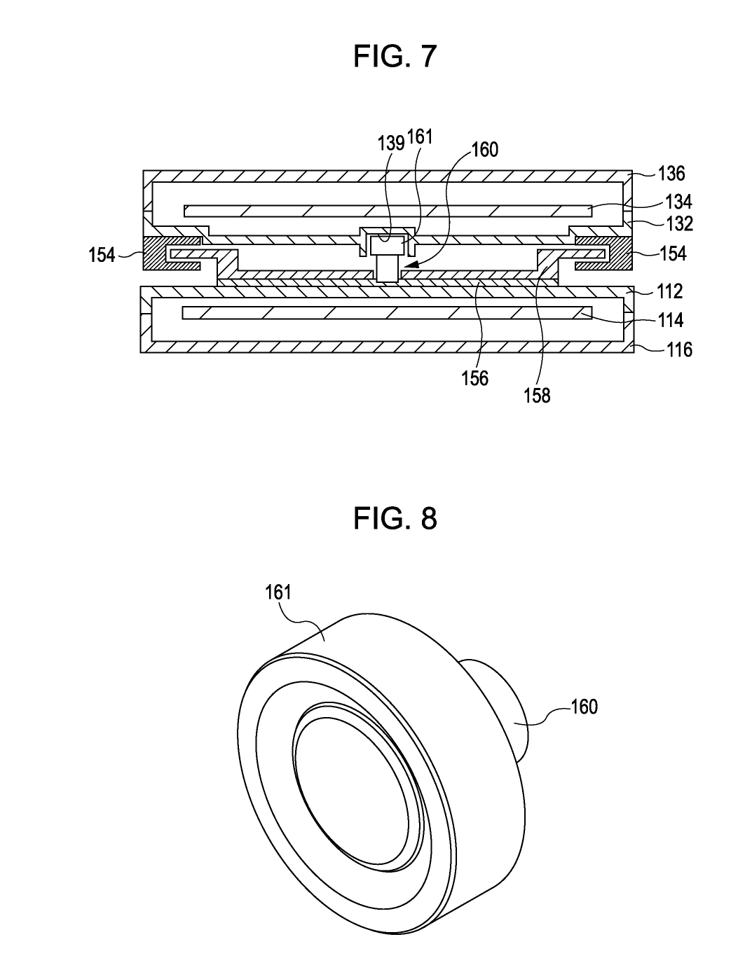

FIG. 7 is a schematic sectional view of the movement regulating recess portion 139 and an area around the movement regulating recess portion 139 of the mobile phone device 100. As illustrated in FIG. 7, the movement regulating recess portion 139 receives the protruding portion 160 disposed between the pair of rail members 154 such that the protruding portion 160 is movable relative to the movement regulating recess portion 139 while the movement regulating recess portion 139 regulates a movable range of the protruding portion 160. The movement regulating recess portion 139 according to the present embodiment regulates the movable range of the protruding portion 160 in a direction in which the movable casing 130 slides relative to the fixed casing 110 and in a direction in which the movable casing 130 rotates relative to the fixed casing 110.

In order to change the state of the mobile phone device 100 into one of the states illustrated in FIGS. 1 to 3, the movable casing 130, to which an external force is applied, is moved relative to the fixed casing 110, and the protruding portion 160 is moved in the movement regulating recess portion 139 within the range regulated by the movement regulating recess portion 139.

A roller member 161 illustrated in FIG. 8 is attached to an end of the protruding portion 160. FIG. 8 is an enlarged perspective view of the roller member 161. The roller member 161 contacts an inner side surface of the movement regulating recess portion 139 and rotates when the protruding portion 160 moves in the movement regulating recess portion 139. This makes movement of the protruding portion 160 be smooth when the protruding portion 160 moves in the movement regulating recess portion 139 in the range regulated by the movement regulating recess portion 139.

As described above, in the mobile phone device 100 according to the present embodiment, the pair of rail members 154 are secured to the movable casing 130. The rail members 154 receive the arm portions 158b of the movable member 152 secured to the fixed casing 110 such that the arm portions 158b are slidable relative to the rail members 154. Also in the mobile phone device 100 according to the present embodiment, the protruding portion 160 of the movable member 152 is movably received by the movement regulating recess portion 139 of the movable casing 130 disposed between the pair of rail members 154. Thus, according to the present embodiment, a rail plate included in a related-art connecting portion, which connects casings to each other, may be omitted. This may suppress an increase in the weight and the size in the thickness direction corresponding to the rail plate. Also according to the present embodiment, an increase in weight of the mobile phone device 100 may be suppressed without the use of a resin rail plate. That is, according to the present embodiment, the weight and the thickness may be reduced while strength is maintained.

In addition, in the mobile phone device 100 according to the present embodiment, the pair of rail members 154 are secured to the movable casing 130. By doing this, an additional advantage in that degradation in the performance of antennas is suppressed may be obtained.

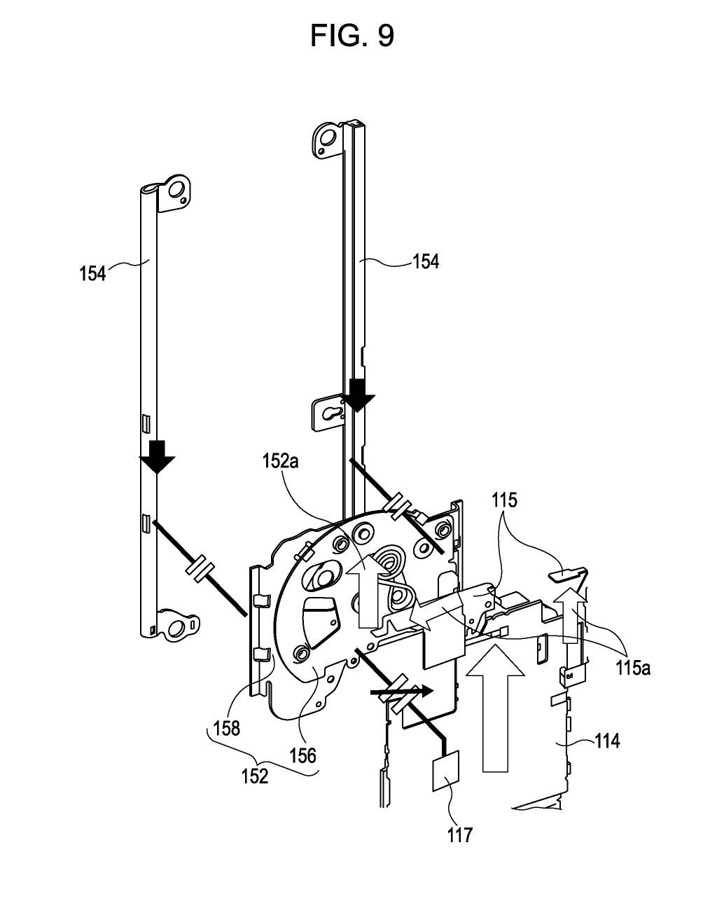

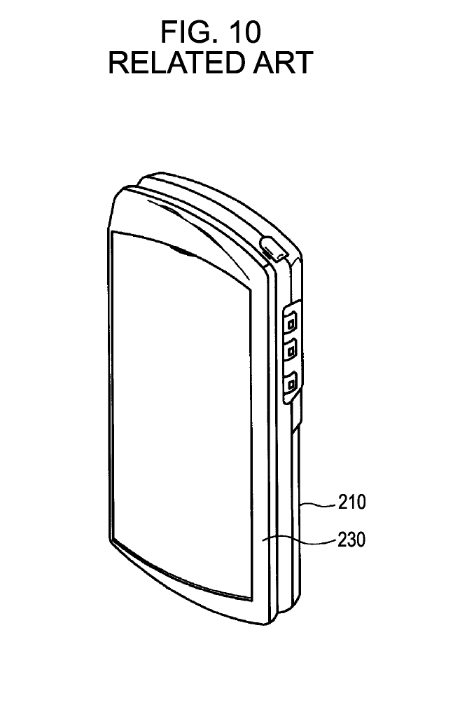

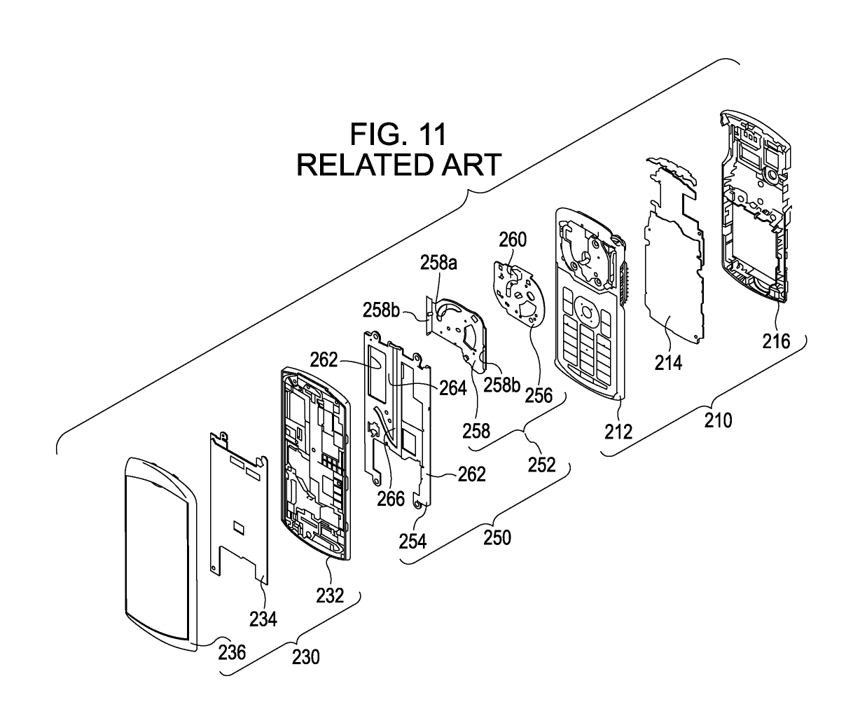

The additional advantage will be described below. FIG. 9 illustrates the relationship between the pair of rail members 154 and antennas 115. As illustrated in FIG. 9, the antennas 115 are mounted on the circuit board 114 provided in the fixed casing 110. The antennas 115 are connected to a feeding point to receive a current from the feeding point and emit electric waves. The electric waves emitted from the antennas 115 cause a high-frequency current to be generated in the movable member 152 and the pair of rail members 154 which are electrically conductive.

When the current flowing in the movable member 152 and the pair of rail members 154 and the current flowing in the antennas 115 are in opposite phase, the current flowing in the antennas 115 is canceled by the current flowing in the movable member 152 and the pair of rail members 154. When the current flowing in the antennas 115 is canceled, the performance of the antennas 115 is degraded.

In order to avoid degradation in the performance of the antennas 115, a phase regulator circuit 117 is mounted on the circuit board 114 in the fixed casing 110. The phase regulator circuit 117 is electrically connected to the metal movable member 152, and adjusts a phase 152a of the current flowing in the movable member 152 such that the phase 152a matches a phase 115a of the current flowing in the antennas 115. By doing this, a situation in which the current flowing in the antennas 115 is canceled by the current flowing in the movable member 152 may be suppressed.

In addition, in the mobile phone device 100 according to the present embodiment, because the pair of rail members 154 are secured to the movable casing 130, the related-art rail plate, which connects a pair of rail portions to each other using a sheet metal portion having a comparatively large surface area, is not used. This allows coupling capacitance between the pair of rail members 154 and the movable member 152 to be decreased compared to the related-art case in which the rail plate is used. Thus, the current flowing in the pair of rail members 154 may be decreased compared to the current flowing in the related-art rail plate.

As described above, in the mobile phone device 100 according to the present embodiment, by mounting the phase regulator circuit 117 on the circuit board 114 in the fixed casing 110, cancellation of the current flowing in the antennas 115 is suppressed. In addition, in the mobile phone device 100 according to the present embodiment, because the pair of rail members 154 are secured to the movable casing 130, the current flowing in the pair of rail members 154 is decreased compared to the current flowing in the related-art rail plate. As a result, degradation in the performance of the antennas may be suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An electronic device comprising:
a first casing;
a second casing including a recess, the recess being disposed on a surface of the second casing, the surface being opposite to the first casing; and
a joint configured to connect the first casing to the second casing so that the first casing and the second casing are movable relative to each other, the joint including:
a movable member fixed to the first casing, the movable member including two arms,
a pair of rails fixed to the second casing, each of the pair of rails receiving a corresponding one of the two arms so that the two arms are slidable relative to the pair of the rails, and
a protrusion protruding from the movable member, the protrusion being disposed between the pair of rails,
wherein the recess is disposed between the pair of rails, and the recess receives the protrusion and regulates movement of the protrusion.

2. The electronic device according to claim 1, wherein the joint includes a roller provided on the protrusion so as to contact an inner side surface of the recess when the protrusion moves in the recess, the inner surface being opposite to an outer cylindrical surface of the roller.

3. The electronic device according to claim 1, wherein the movable member is made of electrically conductive material and the first casing includes,
a circuit board including a feeding point,
an antenna coupled to the feeding point, and
a phase regulator circuit mounted on the circuit board, the phase regulator circuit being coupled with the movable member, wherein the phase regulator circuit adjusts a phase of a current flow in the movable member so that the phase matches a phase of a current flow in the antenna.

4. The electronic device according to claim 2, wherein the movable member is made of electrically conductive material and the first casing includes,
a circuit board including a feeding point,
an antenna coupled to the feeding point, and
a phase regulator circuit mounted on the circuit board, the phase regulator circuit being coupled with the movable member, wherein the phase regulator circuit adjusts a phase of a current flow in the movable member so that the phase matches a phase of a current flow in the antenna.
